(19) United States
(12) Patent Application Publication
(10) Pub. No.: US 2007/0170208 A1
(43) Pub. Date: Jul. 26, 2007

(54) Apparatus and method for processing foodstuffs with liquid

(75) Inventor: Henricus Johannes Josephus Van De Wijgert, Nistelrode (NL)

Correspondence Address: ZARLEY LAW FIRM P.L.C., CAPITAL SQUARE, 400 LOCUST, SUITE 200, DES MOINES, IA, 50309-2350, US

(73) Assignee: Stork Townsend B.V., Oss (NL)

(21) Appl. No.: 10/581,098

(22) PCT Filed: Dec. 2, 2004
(86) PCT No.: PCT/NL04/00842

§ 371 Date: Mar. 5, 2007

(30) Foreign Application Priority Data
Dec. 2, 2003 (NL) 1024926

(51) Int. Cl. G01F 11/00

(52) U.S. Cl. 222/222

(57) ABSTRACT

The invention relates to an apparatus for processing foodstuffs with liquid, comprising: a liquid container, a processing unit for the foodstuff and a feed conduit connecting the liquid container to the processing unit via a pump. The apparatus comprises supply means to add additives. The invention also relates to a method for converting an existing apparatus to such an apparatus, and to a method for processing foodstuffs with liquid using such an apparatus.

The invention relates to an apparatus for processing foodstuffs with liquid and a method for converting an existing apparatus to such an apparatus. The invention also relates to a method for processing foodstuffs with liquid using such an apparatus.

In the production of foodstuffs, for instance meat, fish or dairy products, processing steps often occur wherein the foodstuffs are treated with a liquid. Here can be envisaged the injection of liquid into the foodstuff using an injector device, or sprinkling of the foodstuff with a liquid. The liquid used is generally an aqueous solution which may incorporate additives such as salt, sugar, preservatives, antioxidant, colouring agent, flavouring or aromatic substance. Properties of the foodstuff, such as taste, smell shelf-life and appearance, can be improved by processing with the liquid. It is important for the production process that the additives used are distributed homogeneously through the liquid. Homogeneous distribution is achieved by dissolving the additives or, in the case the liquid is an emulsion or suspension, mixing them in a mixing installation specially designed for this purpose. In such a mixing installation liquid and additives are mixed and/or dissolved for instance by stirring, and homogenized. In limited-scale industrial food production the preparation of the liquid takes place in batches. The homogenized liquid with additives is transferred after preparation to a storage tank of the apparatus for processing the foodstuff with the liquid (for instance the above stated injector device or other processing device). The drawback of the method described here is that a separate mixing installation is required for pumping. A mixing installation is expensive and takes up much space. From an economic viewpoint the acquisition of a mixing installation is therefore not attractive, particularly for smaller producers, and a manual mixing method is preferred. In manual mixing liquid and additives are generally brought together in a mixing tank and stirred manually, which is relatively labour-intensive.

An apparatus for processing foodstuffs with liquid according the preamble of claim 1 is known from EP 1 525 696. This patent discloses an apparatus for injection of treatment solution into slaughtered animals including a container for holding a quantity of treatment solution. The apparatus as disclosed is provided with a plurality of valves enabling the apparatus to establish a flow of solution in a processing mode and a recirculation mode. When the container for holding the treatment solution (the tank) is empty manual valves are closed, the container is disconnect and a new full container is reconnected. Then the manual valves are opened and the processing can be continued. This apparatus has the drawback that a continuous preparation of solution is not possible and that separate means have to be available to prepare (e.g. to mix) treatment solution of line in at least one extra container. This is a relatively costly solution and is also not enabling to adjust the quantity and the quality of the treatment solution in a continuous way.

The present invention has for its object to make it possible in relatively inexpensive manner to mix a liquid with additives mechanically in line in order to process foodstuffs with the thus prepared liquid.

The invention provides for this purpose an apparatus for processing foodstuffs with liquid, according claim 1. The specific location of connecting the supply means to the apparatus enable it to make a solution or mixture of liquid and additives both in a circulating mode and in a processing mode of the apparatus. In the circulating mode the pump will pump round liquid, wherein liquid is pumped out of the liquid container by means of the feed conduit and pumped back into the liquid container by means of the return conduit. The additives will mix with the liquid by introducing the additives into the liquid. By pumping the liquid round for some time in the circulating mode a homogeneous mixture or (depending on the additive) a homogeneous solution is maintained or obtained. After preparation of the liquid for processing the foodstuff, the passage to the processing unit can be opened at any desired moment using the closing means (the so-called processing mode), so that the prepared liquid with additives can be brought into contact with the foodstuff by the processing unit. The return conduit will generally be closed in the processing mode, but it is also possible to envisage a part of the liquid pumped through the feed conduit being pumped back through the return conduit so as to continue homogenizing of the liquid during the processing of the foodstuff. This may be particularly useful when the liquid is a mixture such as an emulsion or a suspension. Another option is to simply supply the additives in the processing mode by feeding the additives directly in the liquid that is pumped to the processing unit. Because the mixing process makes efficient use of a part of the means already present in an existing apparatus, the required additional investment for mechanical mixing is relatively small. Use is thus made for mixing purposes of a pump that is already present; the same pump can be used for both mixing and processing of the food products. This is also the case for multiple use of the liquid container and a part of the conduit system. The present invention also makes efficient use of the space available. The invention also provides the option of preparing a liquid for processing foodstuffs controllably, simply, safely and in mechanical manner.

The supply means preferably connect to the apparatus behind a venturi in a conduit. A venturi is a limited passage in a conduit that lowers the pressure of a transported liquid (medium) just behind the venturi thus providing a suction effect on the additives to be added. The suction effect stimulates the supply of additives. Another effect of the venturi is that it provides turbulence in the liquid, the turbulence has a mixing effect on the liquid and the additives. So other mixing means can be made superfluous. The supply means can connect both to the feed conduit or the return conduit.

In a specific embodiment the venturi is provided with a passage opening having variable dimensions. The variable dimensions of the venturi enable the apparatus to adjust to different process conditions like, liquid flow, properties of the additives, properties of the liquid and so on. An adjustable venturi enables good, or even optimal, mixing conditions under all circumstances. In an even more specific embodiment the venturi is provided with an interchangeable housing incorporating the passage opening. By placing one specific housing of a plurality of interchangeable housings incorporating different types of passage openings in the apparatus it is easy to optimise the venturi. Such a construction is solid and simple in construction.

It is advantageous if the apparatus is provided with supply means for additives, wherein the supply means are adapted to add additives to a liquid before this enriched liquid is fed to the processing unit. The supply means can for instance comprise a funnel or an additive container of other form. The supply means are preferably adapted to the form of the additives to be supplied; solids such as powder and pellets can be added for instance by means of a feed hopper; liquid additives for instance by means of a funnel or an injector; or gaseous additives for instance by means of a needle.

It is advantageous if the supply means connect to the return conduit. As seen in the flow direction in the circulating mode, the supply means are hereby at a distance from the closing means, thereby minimizing the danger that possible high concentrations of additives remaining behind in the vicinity of the supply means find their way as such into the processing unit at switch-over to the processing mode. It therefore also becomes possible to close the return conduit and carry out cleaning, maintenance, replacement or other operations at the supply means, while the apparatus can concurrently process foodstuffs in the processing mode. This can result in more efficient operation.

In a preferred embodiment the supply means are provided with dispensing means. A measured quantity of additive can be fed to the liquid in controlled manner by the dispensing means. The quantity of additive will generally depend on the amount of liquid placed in the liquid container. The dispensing means can for instance comprise a metering valve or a metering tap.

In a preferred embodiment the apparatus is provided with additional mixing means for generating turbulence in the liquid. The additional mixing means improve the mixing of the liquid with the additives, as well as the speed at which this takes place. The additional mixing means can take an active form, for instance in the form of agitators. It is advantageous when the additional mixing means form part of the supply means. The additives are hereby already mixed when added to the liquid, so that mixing and homogenizing can be realized relatively quickly.

In yet another preferred embodiment the additional mixing means can be coupled releasably to the apparatus. This simplifies cleaning of the apparatus. This moreover provides an increased flexibility and effectiveness in that the additional mixing means can be replaced and modified as required, for instance subject to the type and/or volume of additive to be added.

In a preferred embodiment the return conduit is coupled releasably to the liquid container. This has the advantage that the return conduit can be arranged (and optionally removed) in simple manner, which improves the flexibility of the apparatus. The disconnected end of the return conduit can thus be guided for instance in the direction of a drain, for instance during cleaning or flushing of the apparatus. The return conduit can thus also be guided to another device, for instance for treating the liquid. The releasable end of the return conduit can for instance comprise a flexible conduit such as a hose. Another significant advantage is that the extension of an existing apparatus for processing foodstuffs with liquid does not require any special operations in respect of the connection of the return conduit to the liquid container.

The closing means preferably comprise at least one valve. This can for instance be a distributing valve for distributing a liquid flow between the processing unit and the return conduit. It is also possible to envisage an apparatus in which the closing means are formed by a plurality of shut-off valves which can selectively close the different conduits and channels. The valves can take an adjustable form, but valves can also be used which can only be switched between an open and a closed position.

In yet another preferred embodiment, the processing unit comprises an injector for injecting the liquid into the foodstuff. This injector injects the liquid by means of needles into for instance meat products such as sausage, fish products or dairy products such as cheese. The liquid injected can for instance be a salt solution which also incorporates a preservative and a colouring agent. In addition to an injector, the processing unit can for instance also comprise an extrusion or co-extrusion unit or other unit in which foodstuffs are treated with liquid.

The present invention also provides a method for converting an apparatus for processing foodstuffs with liquid, comprising: a liquid container, a processing unit for the foodstuff, a feed conduit connecting the liquid container to the processing unit via a pump, to an apparatus according to any of the foregoing claims, comprising the operational steps of: A) arranging a return conduit which connects to the liquid transport conduit between the pump and the processing unit and which debouches in the liquid container, and B) placing closing means in the feed conduit from the pump to the processing unit and in the return conduit from the pump to the liquid container. In this way an automated mixing functionality can be added inexpensively to an existing apparatus of the above stated type without a relatively expensive mixing installation having to be purchased for this purpose. The conversion can moreover take a relatively compact form, thereby saving space. An extra pump for transferring mixed liquid to the liquid container of the apparatus also becomes unnecessary, since the pump already present in the existing apparatus is utilized.

The present invention also provides a method for processing foodstuffs with liquid using an apparatus as described above, comprising the successive processing steps of: X) mixing liquid and a first additive in a circulating mode of the apparatus, wherein the closing means close the feed conduit from the pump to the processing unit and leave clear the return conduit from the pump to the liquid container, and Y) treating foodstuffs with the liquid in a processing mode of the apparatus, wherein the closing means leave clear the feed conduit from the pump to the processing unit and close the return conduit from the pump to the liquid container. The relatively compact apparatus provides for mixing of additive and liquid in mechanical manner to form a homogeneous liquid suitable for processing foodstuffs.

The additive is preferably added by means of supply means suitable for the purpose which debouch for instance on the return conduit. It is advantageous if the method also comprises the processing step Z) of: mixing the liquid and a second additive in the circulating mode. A plurality of additives, which can be of very differing nature, can hereby be added to the liquid. A large quantity of the same additive can also be added in multiple portions, for instance so as to reduce the danger of blocking the apparatus. This step can of course be repeated a number of times for a plurality of additions of additives. Between the addition of two different additives supply means and additional mixing means can optionally be adapted to the additive to be added (for instance for an additive consisting of solid material or a liquid additive).

The invention will be further elucidated hereinbelow on the basis of several non-limitative exemplary embodiments, in which:

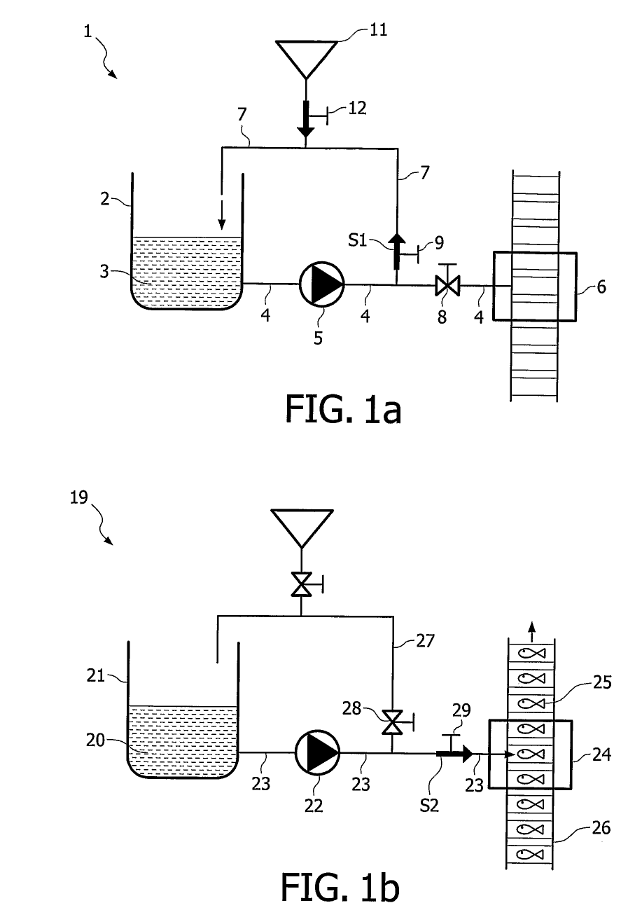

FIG. 1a shows a schematic flow diagram of the apparatus according to the invention in a circulating mode (mixing mode),

FIG. 1b shows a schematic flow diagram of the apparatus according to the invention in a processing mode,

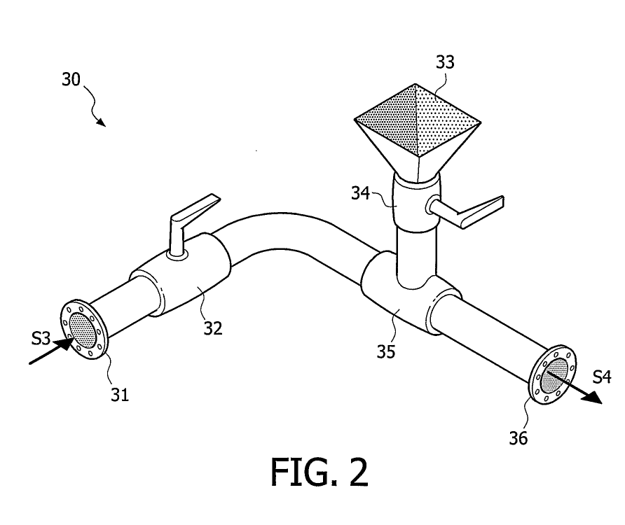

FIG. 2 shows a return conduit for use in an apparatus according to the invention, and

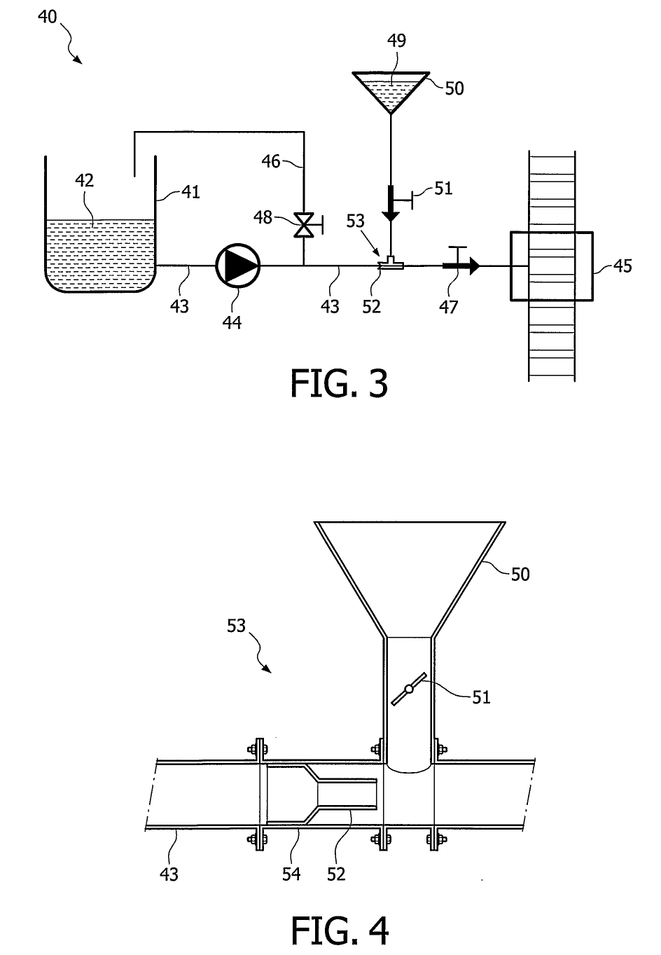

FIG. 3 shows a schematic flow diagram of an alternative embodiment of an apparatus according to the invention, and

FIG. 4 shows a perspective view on a cut-away view of the connection of an additive supply to a conduit of an apparatus according to the invention.

FIG. 1a shows a schematic representation of an apparatus 1 according to the invention in a circulating mode, wherein additives can be mixed with a liquid for processing foodstuffs, and wherein such a liquid or mixture can be homogenized. Apparatus 1 comprises a supply tank 2 for the liquid 3 to which is connected a feed conduit 4 provided with a pump 5 with which liquid 3 can be pumped out of supply tank 2. Feed conduit 4 is connected to a processing unit 6 in which the liquid 3 can be brought into contact with foodstuffs for processing. A return conduit 7 is further connected to feed conduit 4 between pump 5 and processing unit 6, with which return conduit liquid 3 can be fed back to supply tank 2. The outer end of return conduit 7 can for instance be a hose which is easily releasable from the supply tank 2 and can, if desired, be connected temporarily to for instance an external supply tank or a drain conduit. Two adjustable valves 8 and 9 are arranged in the conduit system in order to determine the route along which liquid 3 is transported. The feed to processing unit 6 can be closed using valve 8 and the return conduit can be closed using valve 9. In the circulating mode as shown in this figure, the feed to processing unit 6 is closed by valve 8 and valve 9 is left open (indicated with arrow S1), so that pump 5 pumps liquid 3 through return conduit 7 via a part of feed conduit 3. The circulating mode is particularly suitable for mixing liquid 3 with additives, wherein liquid 3 has to be homogenized by being pumped around for a period of time. After the addition of additives, the total volume of liquid 3 generally has to be pumped round a number of times in order to obtain a sufficiently homogeneous liquid 3. Additives can in principle be brought into contact with the circulating liquid at any point, for instance in supply tank 2. It is however recommended to do this via funnel 11, which is connected to return conduit 7 via the closable valve 12. The funnel is particularly suitable for adding additives in liquid and/or powder form to liquid 3. The additives are mixed with liquid 3 by being pumped around, wherein if possible the additive at least partially dissolves in liquid 3 and a homogeneous solution is thus obtained. The circulating mode of apparatus 1 is otherwise also useful in cleaning of supply tank 2, pump 5 and conduits 4 and 7, wherein a flushing liquid, optionally provided with a cleaning agent, can clean said components of apparatus 1 by circulating the flushing liquid for a period of time. Because the cleaning agent is guided a number of times along the same surface, the desired cleaning result can be achieved with relatively little flushing liquid.

FIG. 1b shows an apparatus 19 comparable to apparatus 1 of FIG. 1a, wherein apparatus 19 is switched to a processing mode. In the processing mode liquid 20 is guided by pump 22 out of supply tank 21 to processing unit 24 via feed conduit 23 for the purpose of processing the foodstuff 25 (in this case fish) which is transported with a conveyor belt 26 through processing unit 24. In the processing mode the return conduit 27 is closed off from feed conduit 23 by means of valve 28. The valve 29 arranged in feed conduit 23 is opened so that liquid 20 can be fed through to processing unit 24 as according to arrow S2. For both functions of the apparatus, the circulating mode (FIG. 1a) and the processing mode (FIG. 1b), the same pump (5 in FIG. 1a, 22 in FIG. 1b) is in principle used, wherein the speed of the pump can, if desired, optionally be modified subject to the function to be performed.

FIG. 2 shows a return conduit 30 for use in an apparatus according to the invention (for instance the apparatus shown in FIGS. 1a and 1b). The intended direction of flow of liquid through the conduit is indicated with arrows S3 and S4. A closable valve 32 is arranged close to the inlet 31 of return conduit 30 to block the passage of liquid. Inlet 31 can for instance be connected to a feed conduit as described in FIG. 1a and 1b. Return conduit 30 is provided with a funnel 33 for adding for instance an additive in liquid or powder form to liquid carried through return conduit 30. Funnel 33 is connected to return conduit 30 via a metering valve 34, wherein the coupling part 35 is provided on the inner side (not shown) with variations, whereby turbulence is created in through-fed liquid such that mixing of through-fed liquid with additive added through funnel 33 is enhanced. A drain hose can for instance be attached to outer end 36 of return conduit 30. In an apparatus according to the present invention, outer end 36 finally debouches onto a liquid container. Return conduit 30 can be integrated into an existing apparatus for processing foodstuffs so as to thus produce an apparatus according to the invention. The functionality of an apparatus can thus be extended advantageously in the above stated manner.

FIG. 3 shows a schematic representation of an alternative embodiment of an apparatus 40 according to the invention. In this embodiment a supply tank 41 for the liquid 42 connects to a feed conduit 43. The feed conduit 43 is provided with a pump 44 with which liquid 42 can be pumped out of supply tank 41. Feed conduit 43 is connected to a processing unit 45 in which the liquid 42 can be brought into contact with foodstuffs for processing. A return conduit 46 is further connected to feed conduit 43 between pump 44 and processing unit 45, with which return conduit liquid 42 can be fed back to supply tank 41. Two adjustable valves 47 and 48 are arranged in the conduit system in order to determine the route along which liquid 42 is transported. The feed to processing unit 45 can be closed using valve 47 and the return conduit can be closed using valve 48. In the processing mode as shown in this figure, the feed to processing unit 45 is opened by valve 47 and valve 48 is closed, so that pump 44 pumps liquid 42 through feed conduit 43 to the processing unit 45. Additives 49 are supplied to the liquid 42 via a funnel 50 which is connected to feed conduit 43 via a valve 51 that is opened in the represented processing mode. The additives 49 are mixed with liquid 42 by being introduced in the feed conduit 43 just behind a restriction 52 (venturi) in the feed conduit 43. The restriction 52 in the feed conduit 43 lowers the liquid pressure just behind the restriction 52.

For a more detailed view on the coupling 53 of the feed conduit 43 and the funnel 50 see FIG. 4. The lower pressure just behind the venturi 52 also provides a turbulence just behind the venturi 52 and thus a homogeneous solution is obtained. The cut-away perspective view according FIG. 4 of the of the connection 53 of an additive supply 50 to a conduit 43 of an apparatus according to the invention also illustrates that the venturi 52 is embedded in a holder 54 that can is releasable. By exchanging the holder 54 for another holder the venturi 52 can be replaced for another venturi having different dimensions.

1. Apparatus for processing foodstuffs with liquid, comprising:
a liquid container,
a processing unit for processing the foodstuff,
a feed conduit connecting the liquid container to the processing unit via a pump,
a return conduit which connects to the feed conduit between the pump and the
processing unit and which debouches in the liquid container, and
closing means for selectively closing the feed conduit from the pump to the processing unit and the return conduit from the pump to the liquid container, characterised in that the apparatus also comprises supply means to add additives, which supply means connect to the apparatus on the side of the closing means in the feed conduit from the pump to the processing unit directed to the liquid container.

2. Apparatus as claimed in claim 1, characterized in that the supply means connect to the apparatus behind a venturi in a conduit.

3. Apparatus as claimed in claim 2, characterized in that the venturi is provided with a passage opening having variable dimensions.

4. Apparatus as claimed in claim 2, characterized in that the venturi is provided with an interchangeable housing incorporating the passage opening.

5. Apparatus as claimed in claim 3, characterized in that the supply means are provided with dispensing means.

6. Apparatus as claimed in claim 1, characterized in that the apparatus is provided with additional mixing means for generating turbulence in the liquid.

7. Apparatus as claimed in claim 6, characterized in that the additional mixing means can be coupled releasably to the apparatus.

8. Apparatus as claimed in claim 1, characterized in that the return conduit is coupled releasably to the liquid container.

9. Apparatus as claimed in claim 1, characterized in that the closing means comprise at least one valve.

10. Apparatus as claimed in claim 1, characterized in that the processing unit comprises an injector for injecting the liquid into the foodstuff.

11. Method for converting an apparatus for processing foodstuffs with liquid, comprising: a liquid container, a processing unit for the foodstuff, a feed conduit connecting the liquid container to the processing unit via a pump to the processing unit, comprising the operational steps of:
A) arranging a return conduit which connects to the liquid transport conduit between the pump and the processing unit and which debouches in the liquid container, and
B) placing closing means in the feed conduit from the pump to the processing unit and in the return conduit from the pump to the liquid container.

12. Method for processing foodstuffs with liquid using an apparatus having comprising:
a liquid container,
a processing unit for processing the foodstuff,
a feed conduit connecting the liquid container to the processing unit via a pump,
a return conduit which connects to the feed conduit between the pump and the
processing unit and which debouches in the liquid container, and
closing means for selectively closing the feed conduit from the pump to the processing unit and the return conduit from the pump to the liquid container, characterised in that the apparatus also comprises supply means to add additives, which supply means connect to the apparatus on the side of the closing means in the feed conduit from the pump to the processing unit directed to the liquid container.

13. Method as claimed in claim 12, characterized in that the method also comprises the processing step Z) of: mixing the liquid and a second additive in the circulating mode.
